(19) United States
(12) Patent Application Publication
(10) Pub. No.: US 2026/0081457 A1
(43) Pub. Date: Mar. 19, 2026

(54) WIRELESS CHARGING SYSTEM CONTROLLING CHARGING POWER TO A MOBILE DEVICE BASED ON MATERIALS USED IN A COVER AND/OR WIRELESS CHARGING SURFACE

(71) Applicant: GM GLOBAL TECHNOLOGY OPERATIONS LLC, Detroit, MI (US)

(72) Inventors: Satish SHARMA, Matawan, NJ (US); John SERGAKIS, Bloomfield Hills, MI (US); Randy L. SWAFFORD, Chesterfield, MI (US)

(21) Appl. No.: 18/888,897

(22) Filed: Sep. 18, 2024

(51) Int. Cl. H02J 7/00; G06V 20/60; H02J 50/10; B60R 16/03

(52) U.S. Cl. CPC H02J 7/975; G06V 20/60; H02J 7/42; H02J 50/10; B60R 16/03

(57) ABSTRACT

A wireless charger for a mobile device includes a coil arranged adjacent to a charging surface. A power conversion module is configured to selectively supply power from a power source to the coil to wirelessly charge the mobile device. A temperature sensor is configured to sense a temperature at the charging surface of the wireless charger. A material sensor is configured to sense a material of a cover of the mobile. A communications and control module is configured to control wireless charging of the mobile device based on the sensed temperature and a temperature range selected in response to the sensed material of the cover of the mobile device.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to wireless charging for mobile devices, and more particularly to a wireless charger that controls charging power based on materials used in a mobile device cover and/or a charging surface of the wireless charger.

Wireless chargers can be used to charge battery systems of mobile devices such as smartphones. The wireless chargers typically follow a standard (such as a Qi Standard) when wirelessly charging devices such as smartphones. The standards typically define a static safe operating temperature range for the mobile device and/or the wireless charger during wireless charging.

### SUMMARY

A wireless charger for a mobile device includes a coil arranged adjacent to a charging surface. A power conversion module is configured to selectively supply power from a power source to the coil to wirelessly charge the mobile device. A temperature sensor is configured to sense a temperature at the charging surface of the wireless charger. A material sensor is configured to sense a material of a cover of the mobile. A communications and control module is configured to control wireless charging of the mobile device based on the sensed temperature and a temperature range selected in response to the sensed material of the cover of the mobile device.

In other features, the communications and control module is configured to receive an output of the material sensor, to sense the material of the cover of the mobile device, and to select the temperature range in response thereto. A wireless charger surface material is arranged between the charging surface of the wireless charger and the mobile device. The communications and control module is further configured to select the temperature range in response to a material of the wireless charger surface material. The material sensor includes a camera.

In other features, the communications and control module is configured to wirelessly communicate with the mobile device. The communications and control module is configured to take a picture of the cover of the mobile device using the camera.

In other features, the communications and control module is configured to take the picture using the camera in response to wireless communications being established with the mobile device. The communications and control module is configured to perform image analysis to identify the material of the cover.

A system comprises the mobile device and the wireless charger. The mobile device includes a camera configured to take a picture of the wireless charger surface material. At least one of the mobile device and the communications and control module is further configured to determine a material of the wireless charger surface material, to perform image analysis to identify the material of the wireless charger surface material, and to select the temperature range further in response to the material of the wireless charger surface material.

A method for wirelessly charging a mobile device includes sensing a material of a cover of the mobile device; selecting a temperature range of a wireless charger in response to the sensed material of the cover of the mobile device; selectively supplying power from a power source to a coil to wirelessly charge the mobile device; sensing a temperature at a charging surface of the wireless charger; and controlling wireless charging of the mobile device by the wireless charger based on the sensed temperature and the temperature range.

In other features, a wireless charger surface material is arranged between a charging surface of the wireless charger and the mobile device. The method includes selecting the temperature range further in response to a material of the wireless charger surface material. Sensing the material of the cover of the mobile device includes taking a picture of the cover of the mobile device. Sensing the material of the cover of the mobile device further includes performing image analysis to identify the material of the cover of the mobile device.

In other features, the method includes accessing a lookup table indexed by the material of the cover of the mobile device to generate the temperature range. The method includes taking the picture of the cover of the mobile device in response to wireless communications being established between the wireless charger and the mobile device. The mobile device includes a camera configured to take a picture of a material of the wireless charger surface material. The method includes determining the material of the wireless charger surface material by performing image analysis. The method includes selecting the temperature range further in response to the material of the wireless charger surface material.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a mobile device located in a cover that is arranged on a wireless charger according to the present disclosure;

FIG. 2 is a functional block diagram of an example of the wireless charger according to the present disclosure;

FIG. 3 is a functional block diagram of an example of a mobile device including a wireless charger according to the present disclosure;

FIG. 4 is a flowchart of an example of a method for wirelessly charging the mobile device according to the present disclosure;

FIG. 5 is a flowchart of an example of a method for determining a temperature range for a material of the cover according to the present disclosure;

FIG. 6 is a flowchart of an example of a method for determining a temperature range for a material at a charging surface of the wireless charger according to the present disclosure; and

FIG. 7 is a flowchart of an example of a method for monitoring temperature during charging of the mobile device based on materials used for the cover and/or wireless charging surface according to the present disclosure.

In the drawings, reference numbers may be reused to identify similar and/or identical elements.

### DETAILED DESCRIPTION

While the wireless charger is shown and described below in the context of a charging a smartphone in a vehicle, the wireless charger can be used to charge any mobile device including a battery in vehicle, non-vehicle, or stationary applications.

Wireless chargers can be used to charge batteries of mobile devices such as smartphones. During charging, power is supplied to one or more coils in the wireless charger. The coils couple with coils in the mobile device to wirelessly transfer power without requiring a direct connection. The wireless chargers typically follow a standard (such as a Qi Standard) when wirelessly charging devices such as smartphones. The standards typically define a static safe operating temperature range for all of the mobile devices that may be charged.

The mobile device monitors battery temperature during charging. The wireless charger may monitor the temperature of internal electronics of the wireless charger during charging. However, wireless chargers do not typically monitor the temperature at a charging surface of the wireless charger or at the cover of the mobile device. As a result, materials located on a charging surface of the wireless charger and/or the cover of the mobile device may be damaged during charging or heated to a temperature that may be too hot for handling. In other examples, a metal object may be inadvertently placed between the mobile device and the wireless charger. The metal object will increase the temperature of the charging surface of the wireless charger and/or the cover of the mobile device and cause damage or excessive heating.

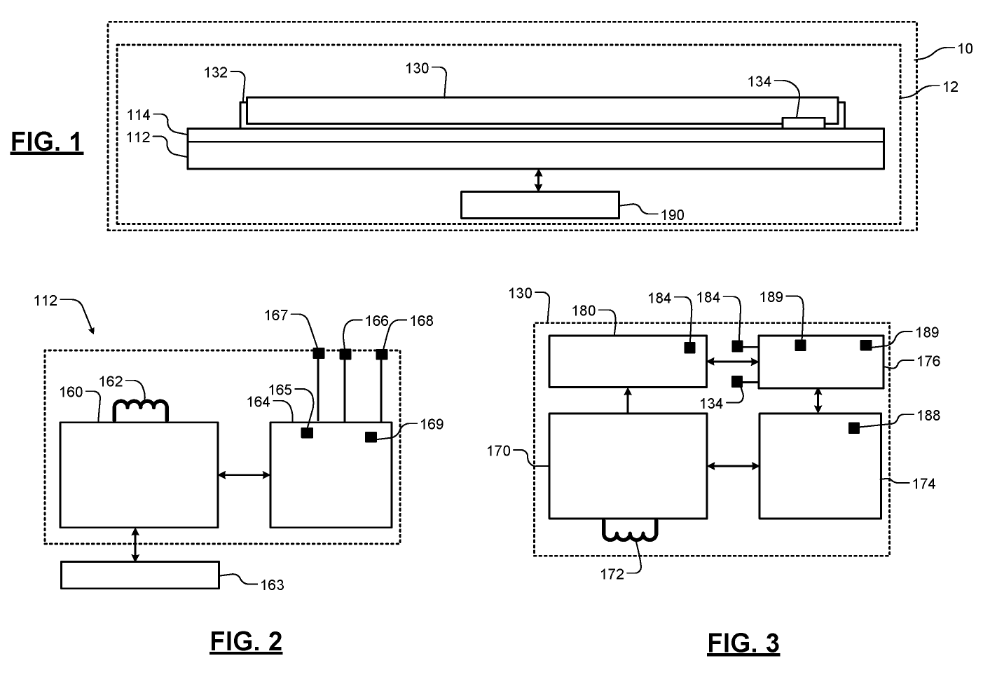

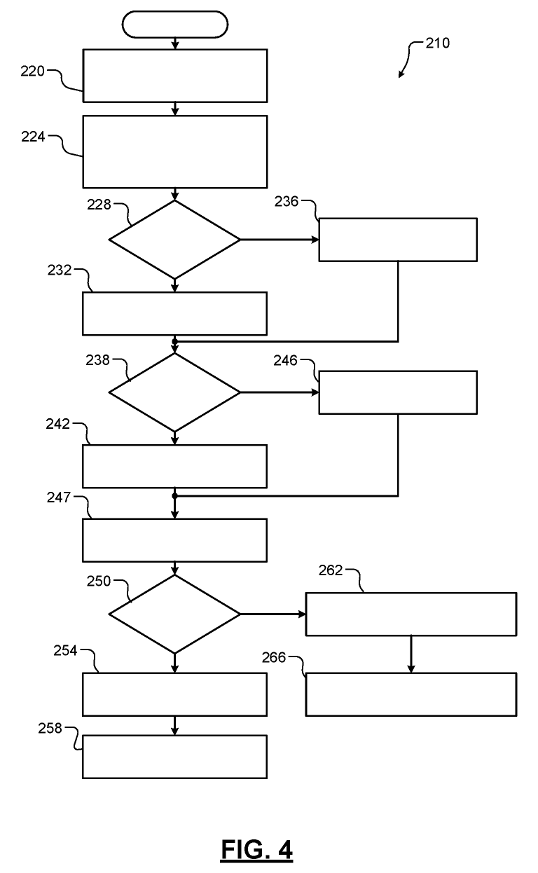

Referring now to FIG. 1, a wireless charger 112 includes a charging surface 114. In some examples, the wireless charger 112 is arranged on or integrated with an interior component 12 of a vehicle 10. In some examples, the charging surface 114 is made of a material such as plastic, rubber, leather, fiber, and/or other suitable material. A mobile device 130 includes a battery (FIG. 2) that is wirelessly charged by the wireless charger 112. In some examples, a cover 132 surrounds a back side of the mobile device 130. In some examples, the cover 132 is made of a material such as plastic, leather, fiber, and/or other material.

During charging, the cover 132 of the mobile device 130 is in contact with the wireless charging surface 114 of the wireless charger 112. In some examples, the mobile device 130 includes a camera 134 adjacent to an opening in the cover 132 or extending through the cover 132. In some examples, the mobile device 130 includes a cellular phone such as a smartphone, although other mobile devices such as a watch, wireless headphones, or other wireless device can be used. In some examples, the wireless charger 112 is arranged in the vehicle 10.

Referring now to FIG. 2, the wireless charger 112 includes a power conversion module 160 connected to a power source 163 (such as an AC or DC source). The power conversion module 160 supplies power to one or more coils 162 that are arranged in the wireless charger 112 in a plane parallel and adjacent to the charging surface 114.

A communications and control module 164 of the wireless charger 112 manages communications with the mobile device 130 during charging. In some examples, the communications and control module 164 and the mobile device 130 communicate using near field channel (NFC) communications and/or other wireless communication protocol. The communications and control module 164 also includes one or more applications 169 that control charging of the battery of the mobile device 130 as will be described further below.

In some examples, the wireless charger 112 includes a temperature sensor 165 to sense a temperature of electronics of the wireless charger. The wireless charger 112 includes one or more temperature sensors 166 arranged in the wireless charger 112 adjacent to the charging surface of the wireless charger 112. In some examples, the one or more temperature sensors 166 are arranged in an array adjacent to the charging surface 114. In some examples, the wireless charger 112 includes one or more material sensors 168 adjacent to the charging surface of the wireless charger 112. In some examples, the one or more material sensors 168 include one or more cameras. In some examples, the charging surface 114 includes openings to allow the camera to view the cover 132 of the mobile device 130.

In some examples, the communications and control module 164 causes the camera takes a picture of the mobile device 130 when the mobile device 130 establishes wireless communications with the wireless charger (in some examples, before or as the mobile device 130 is placed on the charging surface 114). In some examples, the communications and control module 164 performs image analysis to identify the cover 132 and/or the material of the cover 132. In some examples, the wireless charger 112 also includes a cooling device 167 (e.g., a Peltier device or other suitable cooling device) to cool the cover during charging.

In some examples, the communications and control module 164 includes the one or more applications 169 configured to control wireless charging as will be described further below. In other examples, a controller 190 of the vehicle 10 communicates with the wireless charger 112 and includes one or more applications that control charging of the mobile device 130. In other examples, the device controller 176 of the mobile device 130 and/or the communications and control module 174 of the mobile device 130 include one or more applications that control charging. In still other examples, the applications 169 are distributed and executed by two of more of these devices. As can be appreciated, the controller or module controlling charging includes a lookup table (LUT) including materials and corresponding temperature ranges.

Referring now to FIG. 3, the mobile device 130 includes a power conversion module 170, a battery system 180, and a device controller 176. One or more coils 172 are arranged parallel and adjacent to a charging surface (e.g., the cover 132) of the mobile device 130. A communications and control module 174 manages communications with the wireless charger 112 during charging. In some examples, the communications and control module 174 and the wireless charger 112 communicate using NFC communications or other suitable wireless protocol. The communications and control module 174 includes one or more applications to control charging of the battery of the mobile device 130. For example, the communications and control module 174 sends signals to the communications and control module 164 regarding the state of charge of the mobile device 130, sensed temperatures, the material, image analysis of the wireless charging surface, etc.

In some examples, the mobile device 130 includes one or more temperature sensors 184. In some examples, one or more of the temperature sensors 184 are arranged at or near a charging surface of the mobile device 130. The communications and control module 174 includes one or more applications 188 configured to control wireless charging as will be described further below. The device controller 176 includes one or more applications 189 configured to control the mobile device 130.

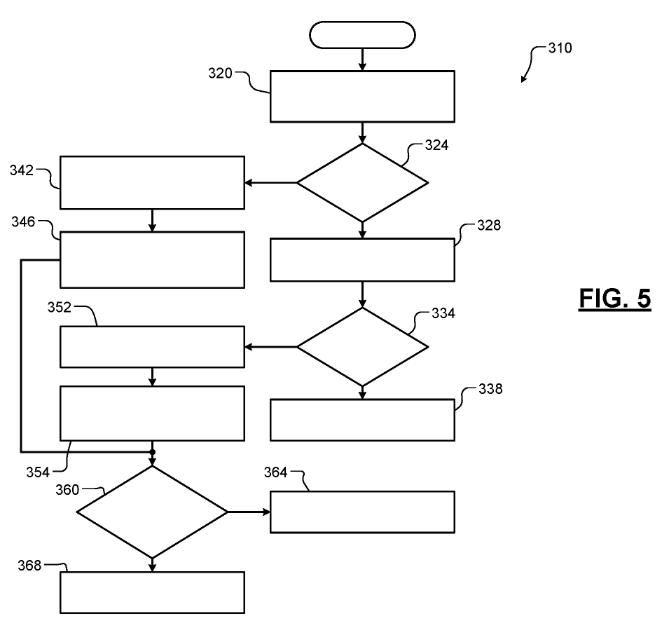

Referring now to FIG. 4, a method 210 for wirelessly charging the mobile device while protecting the device cover material (DCM) and wireless charger surface material (WCSM) is shown. At 220, the temperature range for wireless charging is initialized. In some examples, a Qi standard safe operating temperature range is used. In other words, T_{low} = T_{std_low} and T_{high} = T_{std_high}. At 224, the method determines the temperature range for a device cover material (DCM) and/or the wireless charger surface material (WCM). At 228, the method determines whether the device cover material is calibrated. If 228 is true, a calibrated temperature range is used at 232 (e.g., T_{DCM_low} = T_{DCM_cal_low} and T_{DCM_high} = T_{DCM_cal_high}). If 228 is false, the device cover material temperature range is evaluated at 236 (e.g., T_{DCM_low}, T_{DCM_high}) (see FIG. 5 below).

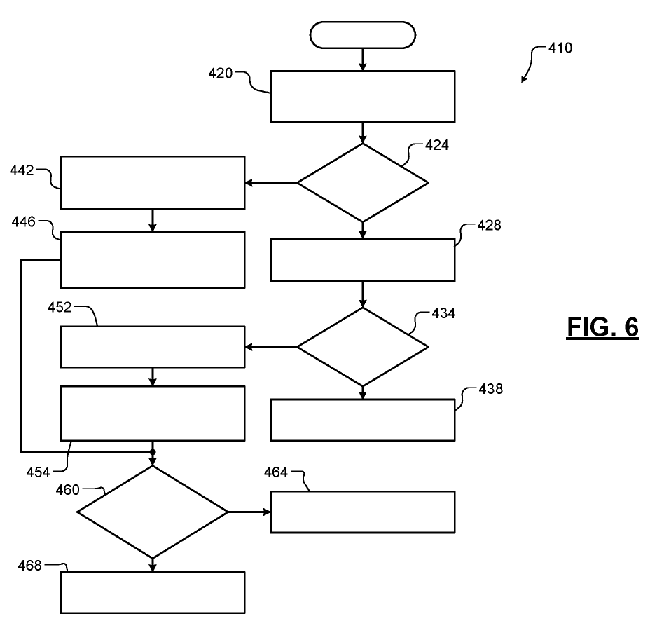

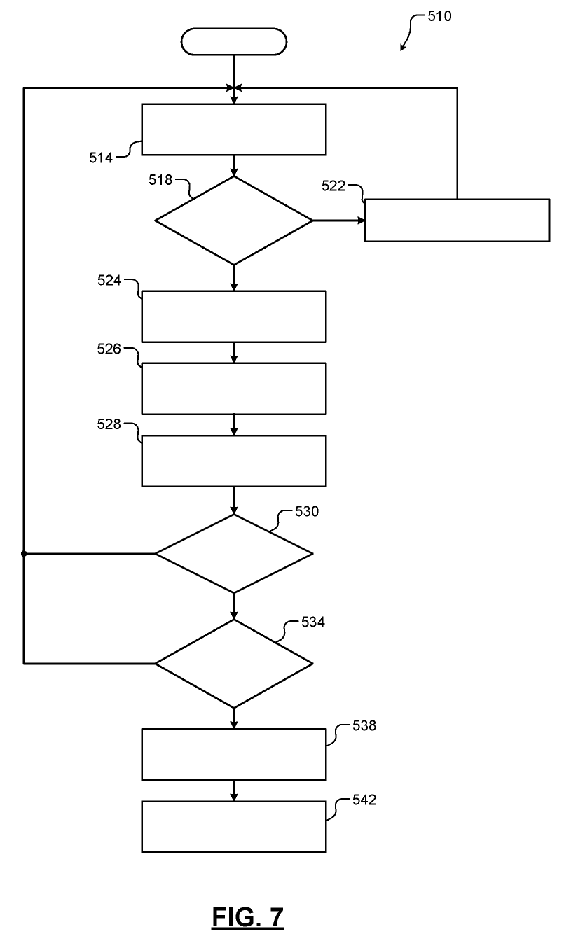

At 238, the method determines whether the wireless charger surface material is calibrated. If 238 is true, a calibrated temperature range is used at 242 (e.g., T_{WCSM_low} = T_{WCSM_cal_low} and T_{WCSM_high} = T_{WCSM_cal_high}). If 238 is false, the device cover material temperature range is evaluated at 246 (e.g., T_{WCSM_low}, T_{WCSM_high}) (see FIG. 6 below).

At 247, the method determines a temperature range for charging wherein T_{low} = higher value of (T_{WCSM_low}, T_{DCM_low}) and T_{high} = lower value of (T_{WCSM_high}, T_{DCM_high}). At 250, the method determines whether T_{high} -T_{low} > 0. If 250 is true, then the temperature range is set to (T_{high}, T_{low}) at 254 and charging continues or is initiated at 258. If 250 is false, the method alerts the user that safe charging is not possible at 262 and charging is stopped or not initiated at 266.

Referring now to FIG. 5, a method 310 for determining a temperature range for the device cover material is shown. At 320, the temperature range for the device cover material is initialized (T_{DCM_low} = T_{DCM_high} = 0). At 324, the method determines whether the wireless charger 112 includes the material sensor 168 configured to sense the material of the cover 132. If 324 is true, the wireless charger 112 determines the device cover material at 328. At 334, the wireless charger determines whether the device cover material is in a lookup table (LUT). The lookup table stores temperature ranges for the different materials. The selected temperature range for a material in the lookup table can be based on material ignition point, material heat accumulation over time, material texture changes including heat and color, and/or skin sensitivity to different temperatures that may cause discomfort or burns.

If 334 is true, the method returns the DCM temperature range (T_{DCM_low} = T_{DCM_tbl_low} and T_{DCM_high} = T_{DCM_tbl_high}) at 338. If 334 is false, the method finds the closest match at 352. At 354, the method alerts the user that the device cover material was not identified and a standard temperature range is being used for the closest material.

If 324 is false and a device cover material sensor is not used, the temperature range is set to the standard temperature range at 342. At 346, the method alerts the user that the device cover material was not identified and a standard temperature range (e.g., the Qi standard temperature) is being used.

Control continues from 346 or 354 with 360. At 360, the method determines whether the user wants to continue charging. If 360 is true, the method returns the DCM temperature range at 368. If 360 is false, the method stops charging or does not initiate charging at 364.

Referring now to FIG. 6, a method 410 for determining a temperature range for the wireless charger surface material is shown. In some examples, the wireless charger surface material is known and the temperature range for the wireless charger surface material is set in advance by the manufacturer.

If the wireless charger surface material is not known or can be changed, a similar procedure can be used to detect the wireless charger surface material. At 420, the temperature range for the wireless charger surface material is initialized (T_{WCSM_low} = T_{WCSM_high} = 0). At 424, the method determines whether the mobile device 130 includes a camera configured to sense the wireless charger surface material. If true, the mobile device determines the wireless charger surface material at 428. At 434, the wireless charger determines whether the WCSM is in a lookup table (LUT). If 434 is true, the method returns the WCSM temperature range (T_{WCSM_low} = T_{WCSM_tbl_low} and T_{WCSM_high} = T_{WCSM_tbl_high}) at 438. If 434 is false, the method finds the closest match at 452. At 454, the method alerts the user that the WCSM was not identified and a standard temperature range is being used for the closest material.

If 424 is false and the WCSM sensor is not used, the temperature range is set to the standard temperature range at 442. At 446, the method alerts the user that the WCSM was not identified and a standard temperature range (e.g., the Qi standard temperature) is being used.

Control continues from 446 and 454 with 460. At 460, the method determines whether the user wants to continue charging. If 460 is true, the method returns the WCSM temperature range. If 460 is false, the method stops charging or does not initiate charging.

Referring now to FIG. 7, a method 510 for monitoring the temperature of the cover and/or charging surface during charging is shown at 524. At 526, the sensed surface temperature generated by the sensor 166 is monitored. At 528, the method determines whether the sensed temperature is within the temperature range (T_{high} > T > T_{low}). If 518 is false, the method continues charging using the wireless charging profile at 522.

If 518 is false, the method alerts the user when the sensed temperature is not in range at 524. At 526, the wireless charger slows charging by reducing the power level. At 528, the wireless charger optionally initiates active cooling. At 530, the method determines whether the WCSM surface temperature is decreasing due to slowed charging and/or active cooling. If 530 is true, the method returns to 514. If 530 is false, the method determines whether a time limit is reached at 534. If 534 is false, the method returns to 514. If 534 is true, the method stops wireless charging at 538 and alerts the user at 542.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

WHAT IS CLAIMED IS:

1. A wireless charger for a mobile device, comprising:
a coil arranged adjacent to a charging surface;
a power conversion module configured to selectively supply power from a power source to the coil to wirelessly charge the mobile device;
a temperature sensor configured to sense a temperature at the charging surface of the wireless charger;
a material sensor configured to sense a material of a cover of the mobile device; and
a communications and control module configured to control wireless charging of the mobile device based on the sensed temperature and a temperature range selected in response to the sensed material of the cover of the mobile device.

2. The wireless charger of claim 1, wherein the communications and control module is configured to receive an output of the material sensor, to sense the material of the cover of the mobile device, and to select the temperature range in response thereto.

3. The wireless charger of claim 2, further comprising a wireless charger surface material arranged between the charging surface of the wireless charger and the mobile device.

4. The wireless charger of claim 3, wherein the communications and control module is further configured to select the temperature range in response to a material of the wireless charger surface material.

5. The wireless charger of claim 3, wherein the material sensor includes a camera.

6. The wireless charger of claim 5, wherein the communications and control module is configured to wirelessly communicate with the mobile device.

7. The wireless charger of claim 6, wherein the communications and control module is configured to take a picture of the cover of the mobile device using the camera.

8. The wireless charger of claim 7, wherein the communications and control module is configured to take the picture using the camera in response to wireless communications being established with the mobile device.

9. The wireless charger of claim 8, wherein the communications and control module is configured to perform image analysis to identify the material of the cover.

10. A system comprising:
the mobile device; and
the wireless charger of claim 4,
wherein the mobile device includes a camera configured to take a picture of the wireless charger surface material, and
wherein at least one of the mobile device and the communications and control module is further configured to determine a material of the wireless charger surface material, to perform image analysis to identify the material of the wireless charger surface material, and to select the temperature range further in response to the material of the wireless charger surface material.

11. A method for wirelessly charging a mobile device, comprising:
sensing a material of a cover of the mobile device;
selecting a temperature range of a wireless charger in response to the sensed material of the cover of the mobile device;
selectively supplying power from a power source to a coil to wirelessly charge the mobile device;
sensing a temperature at a charging surface of the wireless charger; and
controlling wireless charging of the mobile device by the wireless charger based on the sensed temperature and the temperature range.

12. The method of claim 11, wherein a wireless charger surface material is arranged between a charging surface of the wireless charger and the mobile device.

13. The method of claim 12, further comprising selecting the temperature range further in response to a material of the wireless charger surface material.

14. The method of claim 13, wherein sensing the material of the cover of the mobile device includes taking a picture of the cover of the mobile device.

15. The method of claim 14, wherein sensing the material of the cover of the mobile device further includes performing image analysis to identify the material of the cover of the mobile device.

16. The method of claim 15, further comprising accessing a lookup table indexed by the material of the cover of the mobile device to generate the temperature range.

17. The method of claim 16, further comprising taking the picture of the cover of the mobile device in response to wireless communications being established between the wireless charger and the mobile device.

18. The method of claim 12, wherein the mobile device includes a camera configured to take a picture of a material of the wireless charger surface material.

19. The method of claim 18, further comprising:
determining the material of the wireless charger surface material by performing image analysis; and
selecting the temperature range further in response to the material of the wireless charger surface material.

20. A vehicle comprising:
an interior component of the vehicle;
a wireless charger for a mobile device integrated with the interior component of the vehicle comprising:
a coil arranged adjacent to a charging surface;
a power conversion module configured to selectively supply power from a power source to the coil to wirelessly charge the mobile device;
a temperature sensor configured to sense a temperature at the charging surface of the wireless charger;
a material sensor configured to sense a material of a cover of the mobile device; and
a communications and control module configured to control wireless charging of the mobile device based on the sensed temperature and a temperature range selected in response to the sensed material of the cover of the mobile device.
